(19) United States
(12) Patent Application Publication
(10) Pub. No.: US 2026/0308380 A1
(43) Pub. Date: Oct. 8, 2026

(54) PROCESS FOR PRODUCING A BINDER FOR A WARM MIX ASPHALT COMPOSITION

(71) Applicant: STORA ENSO OYJ, Helsinki (FI)

(72) Inventors: Heikki Lotti, Stockholm (SE); Jesper Ekström, Johanneshov (SE)

(73) Assignee: STORA ENSO OYJ, Helsinki (FI)

(21) Appl. No.: 19/482,004

(22) PCT Filed: May 8, 2024
(86) PCT No.: PCT/IB2024/054482

§ 371 Date: Nov. 6, 2025

(30) Foreign Application Priority Data
May 10, 2023 (SE) 2330210-2

(51) Int. Cl. C08L 95/00; E01C 7/26

(52) U.S. Cl. CPC C08L 95/00; E01C 7/26; C08L 2555/22; C08L 2555/24; C08L 2555/52; C08L 2555/82

(57) ABSTRACT

The present invention is directed to a process for preparing a binder for a warm mix asphalt composition. The binder comprises lignin, a renewable and bio-based material, which replaces part of the fossil-based bitumen when the components are used in preparing a warm mix asphalt, that comprises a reduced amount of wax, fatty acid amides, surfactants and emulsifiers.

### FIELD OF THE INVENTION

The present invention is directed to a process for preparing a binder for a warm mix asphalt composition. The binder comprises lignin, a renewable and bio-based material, which replaces part of the fossil-based bitumen when the components are used in preparing a warm mix asphalt, that comprises a reduced amount of wax, fatty acid amides, surfactants and emulsifiers.

### BACKGROUND

Asphalt is generally prepared by mixing aggregate and filler materials with a bitumen-based binder. Bitumen is derived from the heaviest portion from the oil distillation process. It may have different properties due to the different origins of the oil as well as due to the different distillation processes employed. Bitumen can be characterized by the presence of four classes of substances each having different molecular weight ranges: saturates, aromatics, resins, and asphaltenes.

The components for asphalt are normally mixed at temperatures of about 150-180° C., this is referred to as hot mix asphalt (HMA).

To reduce energy consumption when preparing asphalt, mixtures suitable for mixing at a lower temperature than what is commonly used have been developed. This is referred to as warm mix asphalt (WMA) and it is prepared at temperatures of about 100-150° C. The advantage of using lower temperatures is the reduced energy consumption. However, in view of the lower temperature used, additives are required to achieve adequate performance.

The additives can also confer even better performance of WMA in comparison to conventional HMA methods. The effects of the addition of additives into WMA are known to a reasonable extent but not so much is known about the underlying interactions and phenomena which bring about the mechanisms by which these additives confer beneficial features into the warm mix. Additives are being used to minimize the effect of the mixing temperature deficit involved in WMA processes while improving the general properties of the mix.

Several techniques which involve the use of additives exist for the production of WMA. The three generally most accepted are those using (i) organic additives; (ii) chemical additives; and (iii) foaming techniques. Organic additives are usually waxes and fatty acid amides, which are able to reduce the viscosity of the binder above the melting point of the binder. Common waxes used in the production of WMA are Sasobit® and Asphaltan B®. Chemical additives are usually emulsifiers and surfactants that do not reduce the binder viscosity but improve the coating of aggregates by reducing the surface energy of the aggregate/binder interface and/or the inner friction. Products such as Rediset® and Evotherm® are often used. Foaming techniques function by reducing the viscosity of the binder, just like organic additive techniques, but only for a short period of time. This is achieved by introducing small amounts of water in the hot binder (bitumen), causing expansion of the bitumen and the formation of a large quantity of foam. Foaming techniques are subcategorized into (i) water-based processes, which entail the use of injection foaming nozzles; and (ii) water-bearing additives, which involve the use of minerals in the form of zeolites.

Aside from the aforementioned WMA techniques, there are also several combined technologies and products used to produce WMA, like zeolites or fibers with organic additives. These are called hybrid techniques. Hybrid techniques involve a combination of two or more technologies and are used less often. Examples of hybrid techniques are Low Energy Asphalt (LEA) and the Tri-Mix Warm Mix Injection system, which are both technologies that combine chemical and water-based techniques to achieve the required results. In addition to all of the commonly known techniques for WMA production, a technique that uses emulsions to pre-coat aggregates is sometimes used. This technique involves the use of stabilized bituminous emulsion to pre-coat aggregates before the main mixing procedure with asphalt binder.

Since bitumen is obtained from fossil sources that are non-renewable, there is a desire to at least partly replace it by renewable and sustainable bio-based alternatives. Therefore, bio-based alternatives for bitumen are widely sought after for the manufacturing of asphalt and bitumen emulsions. As reported by some earlier patent literature e.g. EP2918640A1 and WO2019/092278, lignins have been identified as suitable additives and replacements for the conventional bitumen and polymeric bitumen in asphalt.

Further, there is a need for an improved method for preparing WMA.

### SUMMARY OF THE INVENTION

The present inventors surprisingly found that by using lignin in the preparation of WMA, the amount of WMA additives can be significantly decreased, thereby facilitating the process for preparing WMA and also decreasing the cost thereof. It is also advantageous to reduce the amount of additives used since some additives may also be toxic or hazardous to handle.

Thus, the present invention is directed to a process for preparing a binder for an asphalt composition or an asphalt composition, comprising the steps of
providing agglomerated lignin;
disintegrating the agglomerated lignin; and
mixing, at a temperature in the range of from 100° to 150° C. the disintegrated lignin with a bitumen blend to obtain a binder for an asphalt composition or mixing, at a temperature in the range of from 100° to 150° C., the disintegrated lignin with an asphalt blend to obtain an asphalt composition; characterized in that the total amount of wax, fatty acid amides, surfactants and emulsifiers in the binder or asphalt composition is in the range of from 0.01 to 3.0% by weight of the bitumen.

The present invention is also directed to a binder for an asphalt composition prepared using the process according to the present invention. The present invention is also directed to an asphalt composition prepared using the binder according to the present invention.

### DETAILED DESCRIPTION

It is intended throughout the present description that the expression “lignin” embraces any kind of lignin, e.g. lignin originated from hardwood, softwood or annual plants. Preferably the lignin is an alkaline lignin generated in e.g. the Kraft process. Preferably, the lignin has been purified or isolated before being used in the process according to the present invention. The lignin may be isolated from black liquor and optionally be further purified before being used in the process according to the present invention. The purification is typically such that the purity of the lignin is at least 90%, preferably at least 95%, more preferably at least 98%, most preferably at least 99%, 99.5% or 99.9%. Thus, the lignin used according to the process of the present invention preferably contains less than 10%, preferably less than 5%, more preferably less than 2% impurities. The lignin may then be separated from the black liquor by using the process disclosed in WO2006031175. Preferably, the lignin has not been chemically modified after its isolation from the black liquor.

The agglomerated lignin preferably has a particle size distribution such that at least 80 wt-% of the agglomerates have a diameter within the range of from 0.1 mm to 5.0 mm, more preferably at least 80 wt-% of the agglomerates have a diameter within the range of from 0.1 mm to 2.0 mm.

The agglomerated lignin is preferably disintegrated to obtain a particle size distribution such that at least 80 wt-% of the disintegrated lignin particles have a diameter within the range of from 0.001 mm to 1.0 mm. The disintegration can be carried out using methods and equipment known in the art, such as by crushing or milling.

Preferably, the disintegration is carried out such that at least 50 wt % of the disintegrated lignin particles have a diameter in the range of from 1 μm to 500 μm.

In one embodiment of the present invention, the disintegration is carried out at an asphalt plant. Thus, lignin can be transported to the asphalt plant in the form of agglomerated lignin, preferably having a particle size distribution such that at least 80 wt-% of the agglomerates have a diameter within the range of from 0.1 mm to 5.0 mm. The agglomerated lignin is then subjected to disintegration, preferably at the same location at which the lignin is mixed with the bitumen blend or asphalt blend. The handling of the lignin is significantly simplified when the lignin is transported in the agglomerated form.

The bitumen blend used according to the present invention comprises bitumen and optionally for example vegetable oil.

The bitumen used in the bitumen blend, with which the disintegrated lignin is mixed, is derived from the heaviest portion from the oil distillation process. It may have different properties due to the different origins of the oil as well as due to the different distillation processes employed. However, bitumen can be characterized by the presence of four classes of substances each having different molecular weight ranges: saturates, aromatics, resins, and asphaltenes. The bitumen in the bitumen blend used according to the present invention may be selected from virgin bitumen, recycled bitumen, or mixtures thereof. In the bitumen blend, the bitumen may be present in an amount of at least 1, 10, 15, 20, 25, 30, 40, 50, 60, 70, 80, 90, 100 wt. % and/or at most 300, 250, 200, 180, 150, 125, 110 wt. %, preferably 80-120 wt. % with respect to the weight of the disintegrated lignin. The lignin preferably replaces 40-60 wt-% of the bitumen.

The bitumen blend may also comprise other components. For example, the bitumen blend may comprise vegetable oil, or non-fossil derived oil, preferably chosen from linseed oil, soybean oil, sunflower oil, and safflower oil. Preferably, the vegetable oil has a dynamic viscosity of 0.01-1600 Pa·s at 20° C. or 0.01-1000, 0.03-500, or 0.05-250, preferably 0.1-100, 0.2-50, 0.3-20, 0.4-10, 0.5-5 or 0.5-2 Pa·s at 20° C. Kinematic viscosity may be determined by using an Ubbelohde viscometer according to ASTM D 445 or its equivalent BS 188. The dynamic viscosity can be calculated from the kinematic viscosity data by multiplying the latter by the density.

As used herein, the term “asphalt blend” refers to a blend comprising aggregates and optionally a binder, such as bitumen. The asphalt may be or comprise reclaimed asphalt pavement.

As used herein, the term “asphalt composition” refers to the composition obtained by the method according to the present invention.

To obtain an asphalt composition, the binder is mixed with aggregates, such as sand, stone and/or rubble. Typically, the asphalt composition comprises about 60-90 wt-% aggregates. According to the present invention, the amount of lignin in the asphalt composition is preferably in the range of from 1 wt-% to 12 wt-%, preferably from 2 wt-% to 7 wt-%. The mixing is carried out at a temperature in the range of from 100° to 150° C., such as from 110° to 145° C., preferably from 120° to 145° or from 130° C. to 145° C. or from 135° C. to 145°.

The lignin can be mixed with the bitumen blend and the mixture of lignin and the bitumen blend is then mixed with the aggregates. Alternatively, the bitumen blend may first be mixed with the aggregates and the lignin can then be added to the mixture of the bitumen blend and the aggregates. Alternatively, the lignin can be added to the aggregates in the asphalt blending step prior the dosing of bitumen. In this embodiment, the lignin is preferably added to the aggregates in its agglomerated form, i.e. wherein the lignin is agglomerated and preferably has a particle size distribution such that at least 80 wt-% of the agglomerates have a diameter within the range of from 0.2 mm to 5.0 mm. The disintegration of the lignin agglomerates to obtain a particle size distribution such that at least 80 wt-% of the disintegrated particles have a diameter within the range of from 0.001 mm to 1.0 mm preferably takes place during mixing with the aggregates, wherein the aggregates may also comprise fibers and/or other fillers. During the mixing, the agglomerated lignin becomes disintegrated. A particular benefit of this embodiment is that a separate disintegration step wherein the lignin agglomerates are disintegrated can be avoided and the process for preparing the asphalt composition can be simplified, still achieving the benefit of reducing the amount of dust forming fines and still obtaining an improved binder composition in which lignin is well dispersed and homogenously distributed. Alternatively, the lignin can be added to reclaimed asphalt pavement prior to it being mixed with asphalt blend.

Recycled aggregates from the steel industry can be used in the preparation of the asphalt composition. However, the asphalt composition preferably comprises less than 5 wt-%, more preferably less than 1 wt-% of steel slag.

The asphalt composition can be used for example as a pavement or road paving.

The binder or asphalt composition according to the present invention may also comprise additives, such as wax, fatty acid amides, surfactants and emulsifiers. In the binder or asphalt composition according to the present invention the total amount of wax, fatty acid amides, surfactants and emulsifiers in the asphalt composition is in the range of from 0.01 to 3.0% by weight of the bitumen, preferably from 0.01 to 1%, more preferably from 0.01 to 0.2%, 0.01 to 0.1%, such as from 0.01 to 0.08% by weight of the bitumen.

The present inventors surprisingly found that by using lignin, the amount of WMA additives can be significantly decreased, thereby facilitating the process for preparing WMA and also decreasing the cost thereof.

In view of the above detailed description of the present invention, other modifications and variations will become apparent to those skilled in the art. However, it should be apparent that such other modifications and variations may be effected without departing from the spirit and scope of the invention.

1. A process for preparing a binder for an asphalt composition or an asphalt composition, comprising the steps of:
providing an agglomerated lignin;
disintegrating the agglomerated lignin to provide a disintegrated lignin; and
mixing, at a temperature in a range of from 100° to 150° C. the disintegrated lignin with a bitumen blend to obtain a binder for an asphalt composition, or mixing, at a temperature in a range of from 100° to 150° C., the disintegrated lignin with an asphalt blend to obtain an asphalt composition,
wherein a total amount of wax, fatty acid amides, surfactants and emulsifiers in the binder or the asphalt composition is in a range of from 0.01 to 3.0% by weight of bitumen.

2. The process according to any claim 1, wherein the agglomerated lignin has a moisture content of from 5 wt-% to 10 wt-%.

3. The process according to claim 1, wherein a purity of the agglomerated lignin is at least 95%.

4. The process according to claim 1, wherein the agglomerated lignin has a particle size distribution such that at least 80 wt-% of agglomerates have a diameter within a range of from 0.1 mm to 5.0 mm.

5. The process according to claim 4, wherein at least 80 wt-% of the lignin agglomerates have a diameter within a range of from 0.1 mm to 2.0 mm.

6. The process according to claim 1, wherein the disintegrating comprises disintegrating the agglomerated lignin to a particle size distribution such that at least 80 wt-% of a disintegrated particles have a diameter within a range of from 0.001 mm to 1.0 mm by mixing the agglomerated lignin with aggregates before addition of the bitumen blend.

7. The process according to claim 6, wherein the aggregates are sand, stone, rubble, or a combination thereof.

8. The process according to claim 7, wherein the mixing is carried out at a temperature in a range of from 110° C. to 145° C.

9. The process according to claim 8, wherein the mixing is carried out at a temperature in a range of from 135° C. to 145° C.

10. The process according to claim 1, wherein the total amount of wax, fatty acid amides, surfactants and emulsifiers in the binder or asphalt composition is in the range of from 0.01 to 1% by weight of the bitumen.

11. The process according to claim 10, wherein the total amount of wax, fatty acid amides, surfactants and emulsifiers in the binder or asphalt composition is in a range of from 0.01 to 0.1% by weight of bitumen.

12. A binder for an asphalt composition obtained by the process according to claim 1.

13. An asphalt composition obtained by the process according to claim 1.

14. A pavement or road paving comprising:
an asphalt composition according to claim 13.
